(19) United States
(12) Patent Application Publication
(10) Pub. No.: US 2008/0293417 A1
(43) Pub. Date: Nov. 27, 2008

(54) Method and System for Implementing Subscriber Terminal Handover Accounting in Broadband Wireless Access System

(75) Inventor: Jin Zhang, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen, Guangdong (CN)

(21) Appl. No.: 12/091,685

(22) PCT Filed: Oct. 24, 2006
(86) PCT No.: PCT/CN2006/002839

§ 371 Date: Jul. 17, 2008

(30) Foreign Application Priority Data
Oct. 27, 2005 (CN) 200510116689.5

(51) Int. Cl. H04Q 7/20

(52) U.S. Cl. 455/436

(57) ABSTRACT

The present invention relates to a method and system for implementing subscriber terminal handover accounting in broadband wireless access system. The present invention mainly includes: first, in a broadband wireless access system, an accounting client entity before handover reports handover accounting information to an accounting server after a subscriber terminal handover; then an accounting client entity after handover reports an accounting handover start message to the accounting server, and an end accounting client entity is responsible for accounting handling of the subscriber terminal. The present invention presents an accounting solution of the handover between the ASN accounting clients in a broadband wireless access network such as WiMAX, and thus guarantees the moving subscriber to collect and report the accounting data continuously, in other words, guarantees the continuity of the accounting handling procedure in the system. The present invention is simple and easy to be realized.

### FIELD OF THE INVENTION

The present invention relates to the technical field of wireless communication, and in particular to a method and system for implementing subscriber terminal handover accounting in broadband wireless access system.

### BACKGROUND OF THE INVENTION

With the development of internet services and wider application of wireless networks, wireless systems, such as general packet radio service (GPRS), 3G, worldwide interoperability for microwave access (WiMAX) and B3G, obtain wide applications and concern. Increase in the number of subscribers and increase of subscriber demands offer new demands for the wireless access network systems. In other words, the systems are required to support large capacity, large data traffic and a variety of services of different quality.

The wireless access networks mainly provide a function of packet data forwarding or routing between service networks and mobile subscribers. Therefore, how to count accounting information provided to the subscribers according to the position region in wireless networks, such as data traffic and service duration, is a problem to be solved in the system.

At present, the system architecture of an accounting network in a WiMAX system is illustrated in FIG. 1, which includes an access service network (ASN), a connectivity service network (CSN) and a mobile subscriber station (MSS).

The ASN is a network function set providing wireless access service for WiMAX terminals, and the ASN includes base station (BS) and access service network gateway (ASN-GW).

In FIG. 1, functions provided by the BS include: providing a layer 2 connectivity of the BS and the MSS, implementing radio resource management, measurement and power control, and air interface data compression and encryption. Functions provided by the ASN-GW include: providing a client function for MSS authentication, authorization and accounting function (as illustrated in FIG. 1, the accounting function entity corresponding to the MSS is located in a certain ASN-GW, and the accounting function entities corresponding to other MSSes may be located in other ASN-GWs), supporting network discovery and selection of the Network Service Provider (NSP), providing a relaying function of layer 3 information for the MSS (for example, IP address allocation and relaying function), and implementing radio resource management. In addition, functions of the ASN-GW further include: ASN domestic handover, MSS paging and location management, tunnels management between the ASN and the CSN which are particularly similar to a foreign agent (FA) in a mobile IP technology, authentication proxy between the ASN and the CSN, and visit location register.

In FIG. 1, the CSN provides IP connectivity service for WiMAX terminals. Functions provided by the CSN mainly include: IP address allocation of the MSS, Internet access, AAA proxy or server, authorization controlling based on the subscribers, tunnels from the ASN to the CSN which are particularly similar to a home agent (HA) in the mobile IP technology, accounting of WiMAX subscribers, settlement between operators (as illustrated in FIG. 1, the accounting server or the accounting agent mainly completes this function), tunnels between the CSNs in a roaming state, handover between the ASNs, and various WiMAX service such as service based on position, multimedia multicast and broadcast service, IP multimedia subsystem service.

The MSS illustrated in FIG. 1 is a mobile subscriber device, and the subscribers use the MSS to access the WiMAX network.

As illustrated in FIG. 1, in the system architecture of the WiMAX accounting network, ASN-GW1 works when the MSS initially builds a session. ASN-GW2 works after the MSS mobile handover. The MSS accesses the Internet through the BS, the ASN-GW and the HA, and uses data service. The handover procedure between the ASN-GWs in FIG. 1 is illustrated in FIG. 2, which may include steps below:

Step 21: The MSS sends a handover request message to BS3, and the handover request message carries an identification list of a neighboring handover target candidate BS.

Step 22: BS3 transmits the handover request message of the MSS to ASN-GW1, and the handover request message carries an identification list of a neighboring handover target candidate BS.

Step 23a and Step 23b: ASN-GW1 finds that the neighboring handover target candidate BS1 belongs to ASN-GW2 and ASN-GWn, and transmits the handover request message carrying an identification list of the handover target candidate BS of the two gateways to the two ASN-GWs.

Step 24a and Step 24b: ASN-GW1 receives a handover response message from ASN-GW2 and ASN-GWn, and the message includes a recommended target BSs list of the two gateways.

Step 25: ASN-GW1 transmits the handover response message to BS3, and the message includes an aggregate handover target BSs list.

Step 26: BS3 transmits the handover response message of ASN-GW1 to the MSS.

Step 27: The MSS selects one handover target BS located in ASN-GW2 from the list, and sends a handover acknowledge message to BS3. The message carries identification of the target BS.

Step 28: BS3 transmits the handover acknowledge message of the MSS to ASN-GW1.

Step 29: ASN-GW1 transmits the handover acknowledge message to ASN-GW2, and ASN-GW2 transmits the handover acknowledge message to the handover target BS.

Step 210: The MSS hands over a session to ASN-GW2, and the data flow sent to the MSS goes through ASN-GW2 and BS1.

The existing WiMAX illustrated in FIG. 2 only has a corresponding message handover handling procedure, but does not have a handover accounting procedure between accounting clients. Therefore, the accounting server can not know that the MSS has handed over between two accounted clients, and then problems occur in the accounting procedure such as failing accounting and inaccurate accounting.

The other broadband wireless access systems similar to the WiMAX system do not have the corresponding handover accounting handling solution either, in other words, problems resulted from the defect of the handover procedure such as failing accounting or inaccurate accounting also exist in a broadband wireless access system.

### SUMMARY OF THE INVENTION

The present invention provides a method and system for implementing subscriber terminal handover accounting in broadband wireless access system, which guarantees an accounting server to obtain the information that a subscriber terminal has handed over between the corresponding accounting client entities after the subscriber terminal in a wireless communication system hands over, and guarantees the continuity of the accounting.

Technical solutions of the present invention include:

a method for implementing subscriber terminal handover accounting in broadband wireless access system includes:

in a broadband wireless access system, an accounting client entity before handover reports handover accounting information to an accounting server during a subscriber terminal handover procedure or after the handover procedure;

an accounting client entity after handover is responsible for accounting handling for the subscriber terminal after the subscriber terminal completes the handover.

Optionally, the accounting client entity before handover reporting the handover accounting information to the accounting server includes:

the BS or the ASN-GW where the accounting client entity before handover is located receives a handover acknowledge message of the handover procedure, and the accounting client entity before handover reports the handover accounting information to the accounting server.

Optionally, the handover accounting information includes at least one of:

identification information of a session of a subscriber terminal before handover, duration of the session, data traffic information, and identification information of the BS or ASN-GW after handover.

Optionally, the method further includes:

after the subscriber terminal completes the handover, an accounting client entity after handover reports accounting handover start information to the accounting server, which triggers the accounting client entity after handover to handle accounting for the subscriber terminal. The accounting handover start information includes at least one of:

identification of the handover subscriber terminal, identification of a session of the subscriber terminal after handover, and identification information of the BS or the ASN-GW.

Optionally, the reporting the accounting handover start information includes:

the BS or the ASN-GW where the accounting client entity after handover is located acknowledges that the session has been handed over to the locality, and the accounting client entity after handover reports the accounting handover start information to the accounting server.

Optionally, the method further includes:

if the handed over subscriber terminal is a prepaid subscriber, the accounting server returns accounting quota information to the subscriber terminal after receiving the accounting handover start information sent by the accounting client entity after handover.

A system for implementing subscriber terminal handover accounting in broadband wireless access system includes a handover accounting information report module and an accounting handling module after handover.

The handover accounting information report module sends handover accounting information of a subscriber terminal in an accounting client to an accounting server during a subscriber terminal handover procedure or after the handover procedure.

The accounting handle module after handover controls the accounting client entity after handover handling an accounting for the subscriber terminal. Optionally, the handover accounting information report module is arranged in an accounting client entity before handover.

Optionally, the system further includes an accounting handover notifying module arranged in an accounting client entity after handover, and the module sends accounting handover start information of the accounting client entity after handover to the accounting server, so as to trigger the accounting handling module after handover.

From the above technical solutions, the present invention proposes an accounting solution of the handover among the ASN accounting clients, so as to guarantee the ASN accounting clients to collect and report the accounting data continuously during the move of the subscribers, in other words, to guarantee the continuity of the accounting handling procedure in a broadband wireless access system, such as the WiMAX. Therefore, the implementation of the present invention may guarantee to perform the corresponding accounting operation accurately after the handover. In addition, the present invention is simple and easy to be realized.

### BRIEF DESCRIPTION OF THE DRAWINGS

FIG. 1 is a schematic diagram illustrating the system architecture in the WiMAX system;

FIG. 2 is a schematic diagram illustrating the handover procedure between the ASN-GWs in FIG. 1;

FIG. 3 is a schematic diagram 1 illustrating a particular implementation handling procedure of the method of the present invention;

FIG. 4 is a schematic diagram 2 illustrating a particular implementation handling procedure of the method of the present invention; and

FIG. 5 is a schematic diagram illustrating particular implementation architecture of the system of the present invention.

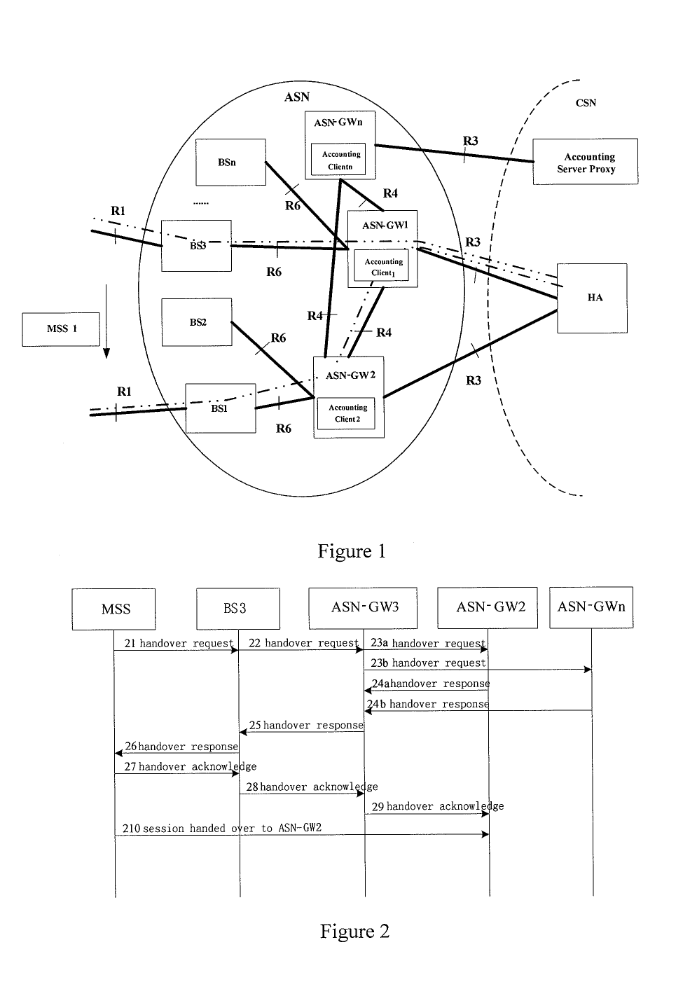

### DETAILED DESCRIPTION OF THE EMBODIMENTS

The present invention provides a method and system for supporting the collecting and reporting an accounting data of handover between ASN accounting clients in a broadband wireless access network such as the WiMAX. In addition, the present invention may be applied in a postpaid ASN accounting client handover procedure, and also may be applied in a prepaid ASN accounting client handover procedure.

A method for implementing subscriber terminal handover accounting provided by the present invention may include:

(1) In a broadband wireless access system, during a subscriber terminal handover procedure or after the handover procedure, the accounting client entity before handover may report handover accounting information to an accounting server after a base station (BS) or an access service network-gateway (ASN-GW) where an accounting client entity before handover is located receives a handover acknowledge message.

The handover accounting information may include at lease one of:

identification information of the session of the subscriber terminal before handover, duration of the session, data traffic information, and identification information of the BS or ASN-GW after handover.

(2) When the BS or the ASN-GW where an accounting client entity after handover is located acknowledges a session has already been handed over to the locality, the accounting client entity after handover needs to report accounting handover start information to the accounting server, for example, the information may be an accounting handover start message, and an end accounting client entity (in other words, the accounting client entity after handover) is responsible for the accounting of the subscriber terminal.

The accounting handover start information may include at least one of:

identification of the handover subscriber terminal, identification of a session of the subscriber terminal after handover, and identification information of the BS or the ASN-GW.

If the handover subscriber terminal is a prepaid subscriber, the accounting server needs to return an accounting quota message to the corresponding accounting client after receiving the accounting handover start message sent by the accounting client entity after handover.

In the present invention, the ASN accounting client may be integrated in an ASN-GW or in a BS. So the handover between ASN accounting clients also has two implementing methods, the following describes the two methods respectively.

For further understanding of the present invention, implementation of the present invention is described in conjunction with exemplary embodiments and the attached drawings.

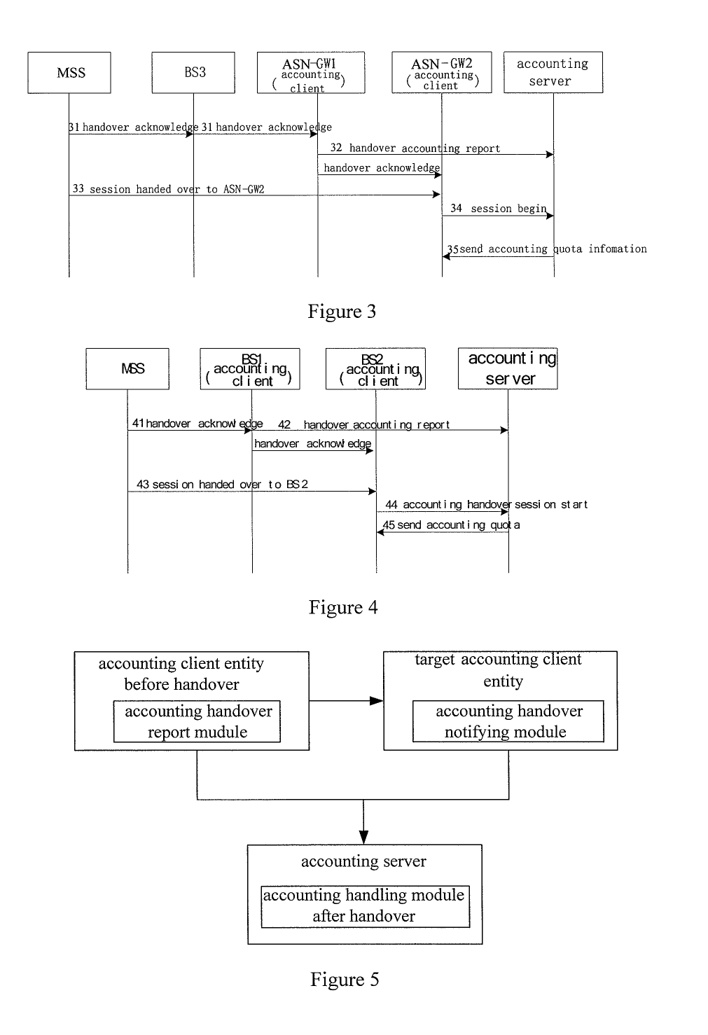

Firstly, a handover accounting implementation solution in which the accounting client is integrated in an ASN-GW is described. As illustrated in FIG. 3, the handover accounting procedure between the ASNs accounting clients may include steps below:

Step 31: ASN-GW1 receives a handover acknowledge message of the MSS transmitted by BS3, and the handover acknowledge message carries identification information of ASN-GW2.

Step 32: The accounting client on ASN-GW1 reports handover accounting information of the accounting client to the accounting server.

The handover accounting information may include at least one of: identification of a session of the MSS before handover, duration of the session of the MSS before handover, data traffic information of the session of the MSS before handover, and identification information of ASN-GW2. It is better that the handover accounting information includes all of the items.

Step 33: The MSS sends information of handing over to ASN-GW2 to ASN-GW2, and ASN-GW2 receives the information transmitted by BS3, in other words, ASN-GW2 receives the information of handing over the session to ASN-GW2 from the MSS.

Step 34: The accounting client on ASN-GW2 reports the accounting handover start information of the session to the accounting server, for example, the information may be an accounting handover start message, and the information may include identification of the MSS, identification of the session of the MSS, and identification of ASN-GW1.

According to accounting demand, step 35 may also be optionally performed, and the step is:

Step 35: If the MSS is a prepaid subscriber, the accounting server sends accounting quota information of the session of the MSS to ASN-GW2.

In the above handling procedure, the step 32, 34 and 35 are new handing procedure of the present invention, and the other handling steps are the prior handover handling procedure between ASN-GWs. Further, the other corresponding handling procedure may also use other applicable handover handling procedure, for example, in the step 31, the message further may be replaced by other messages in the handover procedure, in other words, other handover procedure messages triggers the subsequent step 32.

Secondly, an accounting implementation solution for the ASN accounting client handover in which the accounting client is integrated in a BS is illustrated in FIG. 4, and a corresponding accounting handling procedure between the ASN accounting clients may include steps below:

Step 41: The MSS sends a handover acknowledge message to BS1, then BS1 receives the message from the MSS, and the handover acknowledge message includes identification information of BS2.

Step 42: The accounting client on BS1 reports handover accounting information after BS1 receives the handover acknowledge message, and the handover accounting information includes identification of a session of the MSS before handover, duration of the session, data traffic information, and identification information of BS2.

Step 43: The MSS further sends information that the session hands over to BS2 to BS2, and BS2 receives the corresponding information that the session hands over to BS2 from the MSS.

Step 44: The accounting client on BS2 reports handover start information of the session to the accounting server after BS2 receives the information that the session hands over to BS2, and the information includes identification of the MSS, identification of the session of the MSS, and identification of BS1.

Similarly, step 45 may be performed according to an accounting demand, which is:

Step 45: The accounting server sends accounting quota information of the session from the MSS if the MSS is a prepaid subscriber.

Similarly, in the above handling procedure, the steps 42, 44 and 45 are the new handling procedure of the present invention, and the other steps are the prior handover handling procedure among the ASN-GWs. Furthermore, the other corresponding handling procedure may use other applicable handover handling procedure, for example, in the step 41, the message further may be replaced by other messages during the handover procedure, in other words, other handover procedure messages trigger the subsequent step 42.

The present invention further provides a system for implementing a subscriber terminal handover accounting in broadband wireless access system, as illustrated in FIG. 5, which may include the following handling modules:

a handover accounting information report module arranged in an accounting client entity before handover is configured to send handover accounting information of a subscriber terminal in an accounting client to an accounting server performing accounting handling for a subscriber terminal during the subscriber terminal handover procedure or after the handover procedure (in other words, acknowledging the subscriber terminal handover).

An accounting handling module after handover arranged in the accounting server is configured to control an accounting client entity after handover to be responsible for the accounting handling for the subscriber terminal after the subscriber terminal completes the handover.

An accounting handover notifying module sends accounting handover start information of a target accounting client entity to the accounting server after the session is handed over to the target accounting client entity, and the accounting handover notifying module is arranged in the accounting client entity after handover (in other words, the target accounting client).

The accounting client entity in the system of the present invention is arranged in a base station or an access service network-gateway.

In conclusion, the implementation of the present invention firstly proposes an handover accounting solution between ASN accounting clients in a broadband wireless access internet such as the WiMAX, and thus guarantees the moving subscribers to collect and report the accounting continuously. In addition, the present invention is simple and easy to be realized.

Though illustration and description of the present disclosure have been given with reference to exemplary embodiments thereof, it should be appreciated by persons of ordinary skills in the art that various changes in forms and details can be made without deviation from the spirit and scope of this disclosure, which are defined by the appended claims.

1. A method for implementing subscriber terminal handover accounting in broadband wireless access system, comprising:
reporting, by an accounting client entity before handover, handover accounting information to an accounting server during a subscriber terminal handover procedure or after the handover procedure; and
handling accounting, by an accounting client entity after handover, for the subscriber terminal after the subscriber terminal completes the handover procedure.

2. The method according to claim 1, wherein reporting handover accounting information to an accounting server comprises:
reporting, by the accounting client entity before handover, handover accounting information to the accounting server, after a base station, BS, or an access service network gateway, ASN-GW where the accounting client entity before handover is located receives a handover acknowledge message of the handover procedure.

3. The method according to claim 1, wherein the handover accounting information comprises at least one of:
identification information of a session of the subscriber terminal before handover, duration of the session, data traffic information, and identification information of the BS or ASN-GW after handover.

4. The method according to claim 1, further comprising:
reporting, by the accounting client entity after handover, accounting handover start information to the accounting server after the subscriber terminal completes the handover procedure; triggering, by the accounting client entity after handover, the accounting client entity after handover to handle accounting for the subscriber terminal;
wherein the accounting handover start information comprises at least one of:
identification of the subscriber terminal handed over, identification of a session of the subscriber terminal after handover, and identification information of the BS after handover or the ASN-GW after handover.

5. The method according to claim 4, wherein the reporting accounting handover start information, comprises:
reporting, by the accounting client entity after handover, accounting handover start information to the accounting server when the BS or the ASN-GW where the accounting client entity after handover is located acknowledges that the session has been handed over to the locality.

6. The method according to claim 4, further comprising:
returning, by the accounting server, accounting quota information to the accounting client entity after handover, after the accounting server receives the accounting handover start information from the accounting client entity after handover, if the handover subscriber terminal is a prepaid subscriber.

7. A system for implementing subscriber terminal handover accounting in broadband wireless access system, comprising:
a handover accounting information report module, configured to send handover accounting information of a subscriber terminal in an accounting client to an accounting server during a subscriber terminal handover procedure or after the handover procedure; and
an accounting handle module after handover, configured to control an accounting client entity after handover to handle accounting for the subscriber terminal.

8. The system according to claim 7, wherein the handover accounting information report module is arranged in an accounting client entity before handover.

9. The system according to claim 7, wherein the system further comprises:
an accounting handover notifying module arranged in the accounting client entity after handover, configured to send accounting handover start information of the accounting client entity after handover to the accounting server, so as to trigger the accounting handling module after handover.

10. The system according to claim 7, wherein the accounting client entity is arranged in a base station or an access service network-gateway.

11. The method according to claim 2, further comprising:
reporting, by the accounting client entity after handover, accounting handover start information to the accounting server after the subscriber terminal completes the handover procedure; triggering, by the accounting client entity after handover, the accounting client entity after handover to handle accounting for the subscriber terminal;
wherein the accounting handover start information comprises at least one of:
identification of the subscriber terminal handed over, identification of a session of the subscriber terminal after handover, and identification information of the BS after handover or the ASN-GW after handover.

12. The method according to claim 3, further comprising:
reporting, by the accounting client entity after handover, accounting handover start information to the accounting server after the subscriber terminal completes the handover procedure; triggering, by the accounting client entity after handover, the accounting client entity after handover to handle accounting for the subscriber terminal;
wherein the accounting handover start information comprises at least one of:
identification of the subscriber terminal handed over, identification of a session of the subscriber terminal after handover, and identification information of the BS after handover or the ASN-GW after handover.

13. The method according to claim 11, wherein the reporting accounting handover start information, comprises:
reporting, by the accounting client entity after handover, accounting handover start information to the accounting server when the BS or the ASN-GW where the accounting client entity after handover is located acknowledges that the session has been handed over to the locality.

14. The method according to claim 12, wherein the reporting accounting handover start information, comprises:
reporting, by the accounting client entity after handover, accounting handover start information to the accounting server when the BS or the ASN-GW where the accounting client entity after handover is located acknowledges that the session has been handed over to the locality.

15. The method according to claim 11, further comprising:
returning, by the accounting server, accounting quota information to the accounting client entity after handover, after the accounting server receives the accounting handover start information from the accounting client entity after handover, if the handover subscriber terminal is a prepaid subscriber

16. The method according to claim 12, further comprising:
returning, by the accounting server, accounting quota information to the accounting client entity after handover, after the accounting server receives the accounting handover start information from the accounting.

17. The system according to claim 8, wherein the accounting client entity is arranged in a base station or an access service network-gateway.

18. The system according to claim 9, wherein the accounting client entity is arranged in a base station or an access service network-gateway.
